(19) United States
(12) Patent Application Publication
(10) Pub. No.: US 2008/0037956 A1
(43) Pub. Date: Feb. 14, 2008

(54) Systems and Methods of Generating Encapsulated MPEG Program Streams

(75) Inventors: Ramesh Nallur, Suwanee, GA (US); Benjamin Cook, Flowery Branch, GA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/428,342

(22) Filed: Jun. 30, 2006

(51) Int. Cl. H04N 7/26

(52) U.S. Cl. 386/112

(57) ABSTRACT

Systems and method for encapsulating an MPEG program stream in an MPEG transport stream are disclosed. In one embodimen comprises the steps of: receiving a plurality of elementary streams, each of the elementary streams divided into access units; and generating an MPEG transport stream which encapsulates an MPEG program stream by combining, in order, a program stream pack header, a packetized elementary stream (PES) packet produced from one of the elementary streams, and a PES padding stream packet. so that total size of the pack header, PES packet and PES padding stream packet is equal to a size derived from a predefined pack size.

### CROSS REFERENCE TO RELATED APPLICATIONS

Not applicable.

### FIELD OF THE DISCLOSURE

The present disclosure relates to MPEG transport streams, and more specifically, to generating an MPEG transport stream which encapsulates an MPEG program stream.

### BACKGROUND

Many consumers receive entertainment programming in their homes from a cable television operator. Many of today's cable offerings are broadcast using digital signals, which make more efficient use of communication bandwidth, and thus allow more programming to be carried on the same cable. In these cable systems, video programming (e.g., television programs, movies, etc.) is encoded using a Motion Pictures Experts Group (MPEG) standard, and encapsulated into an MPEG transport stream. The MPEG transport stream is transmitted from a cable head-end to the customer premises over a physical medium such as a coax cable, or a hybrid fiber-coax (HFC) cable. At the customer premises, a digital home communication terminal (DHCT) decodes the programming and generates an analog or digital picture signal. The picture is displayed by a television connected to the DHCT.

Some of today's DHCT units incorporate digital video recorder (DVR) functionality, which allows the DHCT to record video programming onto a storage medium such as a disk drive. Some DHCT units incorporate a DVD recorder, which allows the DHCT to record video programming onto a storage device using the DVD-Video format. In some of these DHCT units, the storage device is an optical disk drive. This type of unit is sometimes called a “DVD-burner”. Optical disks recorded in this manner, using the DVD-Video format, can be played back on any DVD-Video player.

The DVD-Video format uses MPEG program streams, while a conventional cable head-end system transmits MPEG transport streams. Therefore, a conventional DHCT that incorporates DVD recorder functionality must do additional processing to first convert the MPEG transport stream into DVD-video-compatible elementary program streams, and then remultiplex the elementary program streams with navigational data into a DVD-video-compatible program stream. Such a conversion involves copying large amounts of data, additional processor power, and additional memory. Thus, a need arises for these and other problems to be addressed.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1A is a block diagram of one embodiment of a system and method for generating encapsulated MPEG program streams is located.

FIG. 2A is a block diagram showing how functionality is distributed between components in one embodiment of the system of FIG. 1.

FIG. 2B is a block diagram showing how functionality is distributed between components in another embodiment of the system of FIG. 1.

FIG. 3 is a block diagram of one embodiment of the program stream generator of FIG. 1.

FIG. 4 illustrates the VOBU and pack data structures as defined by the DVD-Video and MPEG-2 standards.

FIG. 5 is a diagram illustrating an example dual nature transport stream as constructed by transport stream multiplexer of FIG. 2.

FIG. 6A is a diagram illustrating how the dual nature transport stream of FIG. 5 is processed by a conventional MPEG transport demultiplexer.

FIG. 6B is a diagram illustrating how the program stream extractor of FIG. 1 extracts the encapsulated program stream from the dual nature transport stream of FIG. 5.

FIG. 7 is a flowchart describing an exemplary method implemented by the program stream extractor of FIG. 1.

FIG. 8 is a flowchart describing an exemplary method implemented by the packetizer of FIG. 2.

FIG. 9 illustrates an example PES packet constructed from an access unit by the packetizing process of FIG. 8.

FIG. 10 is a state diagram describing an exemplary method implemented by the transport stream multiplexer of FIG. 2 to form a DVD-friendly transport stream.

### DETAILED DESCRIPTION

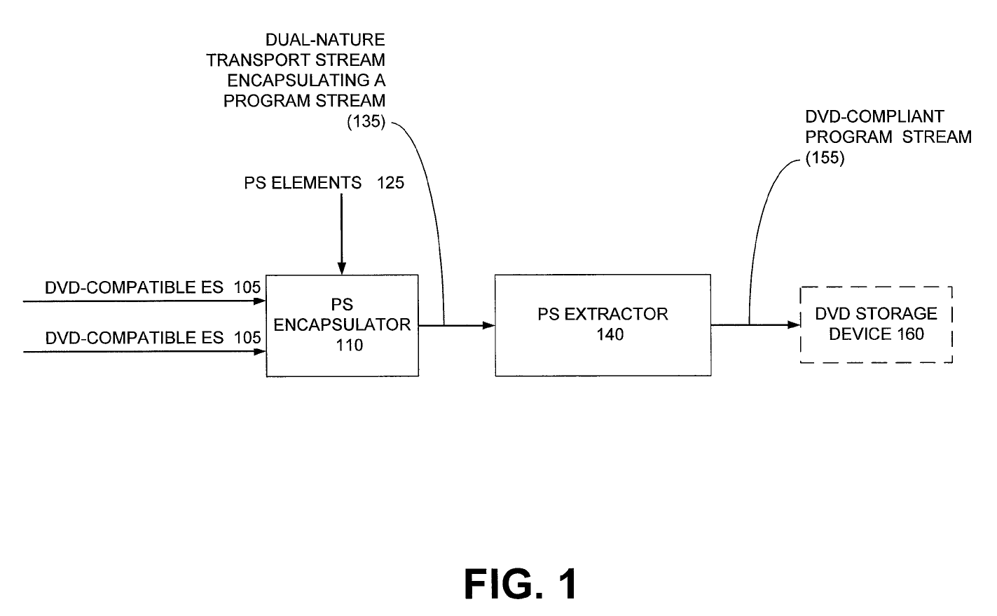

FIG. 1 is a block diagram of one embodiment of a system and method for generating encapsulated MPEG program streams. A program stream encapsulator 110 combines MPEG elementary streams 105 with elements (125) of an MPEG program stream (e.g., pack headers) to produce an MPEG transport stream 135 which contains an MPEG program stream. Transport stream 135 is provided to program stream extractor 140, which extracts the MPEG program stream carried within transport stream 135. Program stream extractor 140 replaces some data in the extracted program stream with other data, producing a DVD-compliant program stream 155. DVD-compliant program stream 155 may be decoded, or optionally be stored on a DVD storage device 160, which in one embodiment is an optical-disk recorder.

The transport stream 135 produced by program stream encapsulator 110 has a novel dual nature. Dual nature transport stream 135 is a special type of transport stream that encapsulates an MPEG transport stream in manner which allows an efficient transformation into a DVD-compliant program stream 155. This aspect of transport stream 135 will be referred to herein as “DVD-friendly”. Dual nature transport stream 135 is at the same time an MPEG-compliant transport stream which can be received and decoded by any conventional MPEG receiver. This enhanced yet backward-compatible transport stream 135 is therefore useful in a variety of embodiments, several examples of which will now be discussed. When discussing transport stream 135 herein, sometimes the term “dual nature transport stream 135” will be used, and sometimes the term “DVD-friendly transport stream 135”, depending on which aspect is being emphasized.

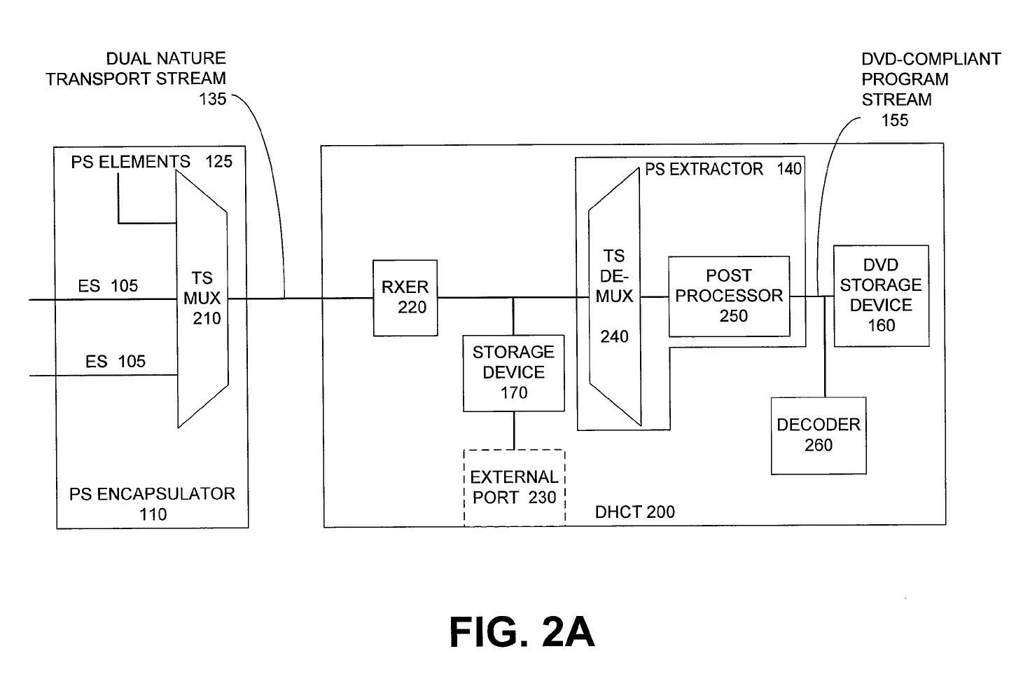

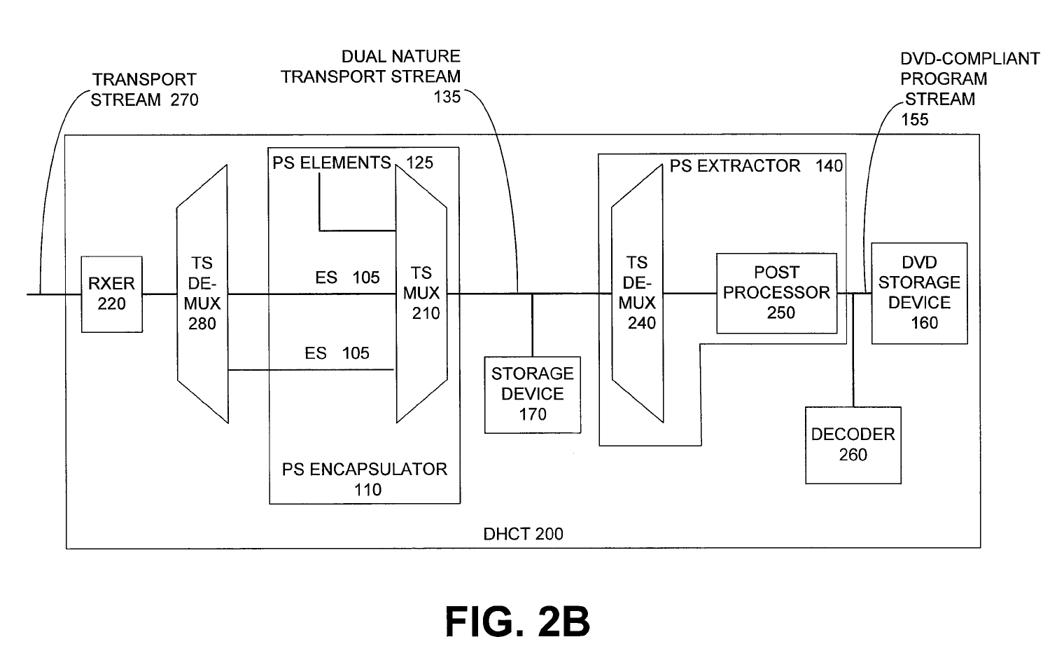

FIG. 2A is a block diagram showing how the functionality of program stream encapsulator 110 and program stream extractor 140 is distributed in one such embodiment. In this embodiment, program stream encapsulator 110 is located at a cable head-end, and program stream extractor 140 is located in a digital home communication terminal (DHCT, or set-top) 200 at a customer premises. In this embodiment, a transport stream multiplexer 210 in program stream encapsulator 110 combines MPEG elementary streams 105 with elements (125) of an MPEG program stream (e.g., pack headers) to produce dual nature transport stream 135.

In this embodiment, the transport stream 135 is received by a receiver 220 in DHCT 200. In some embodiments, the receiver 220 is implemented with a cable radio frequency (RF) tuner. In other embodiments, such as Internet Protocol television (IPTV) receiver 220 is implemented with a network interface.

Once received in DHCT 200, the transport stream 135 may be provided to an external port 230. The external port 230 can be connected to a conventional DHCT, and since transport stream 135 has a dual nature and is a conventional backwards-compatible MPEG transport stream, the conventional DHCT can process the stream for playback. Example embodiments of external port 230 are FireWire (IEEE 1394), Ethernet, and coaxial RF.

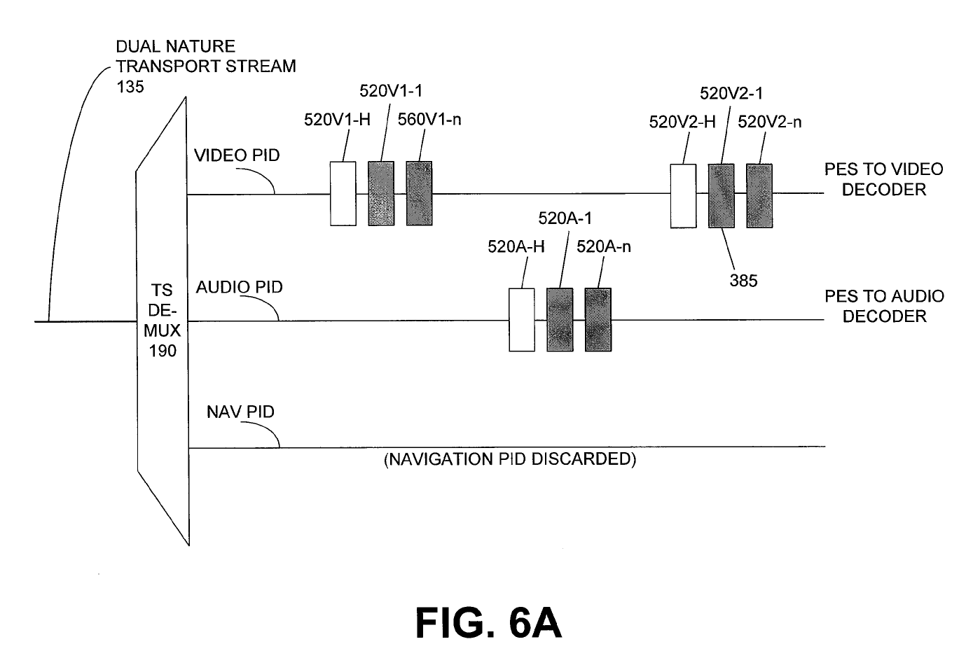

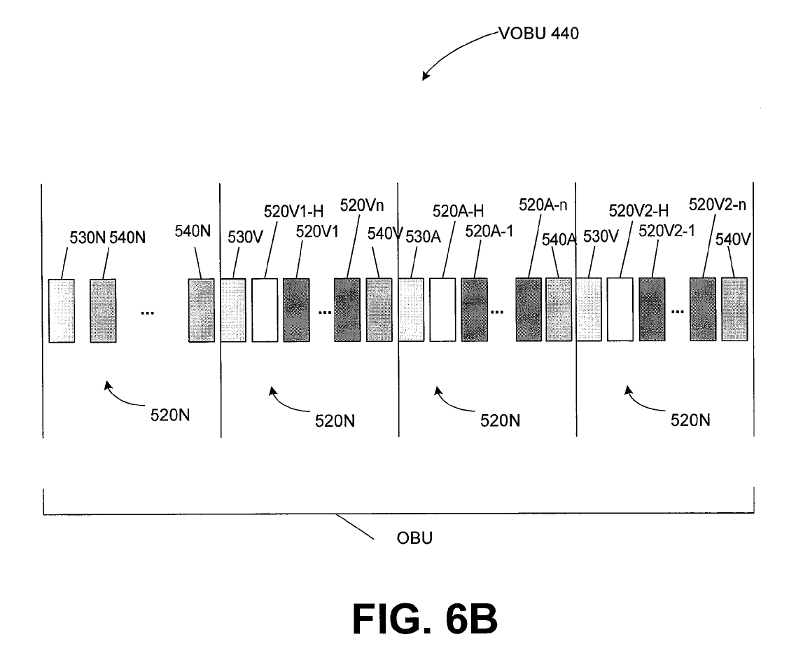

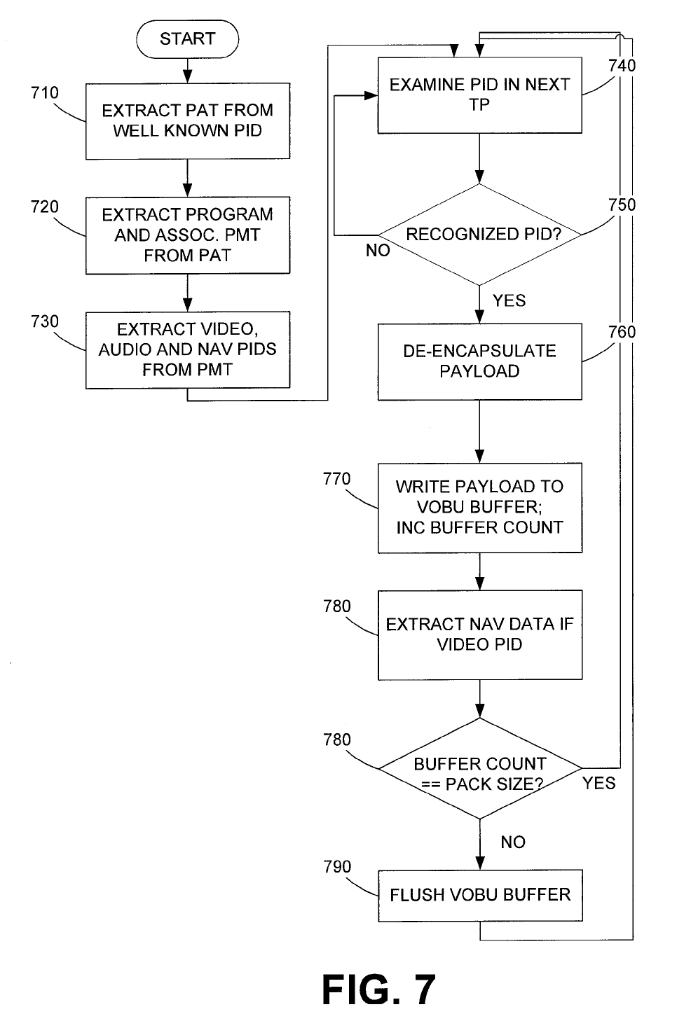

The transport stream 135 is also provided to a storage device 170 such as a disk drive, which in the example embodiment, is different than DVD storage device 160. In other embodiments, storage device 170 is the same as DVD storage device 160. The recorded transport stream 135, which is DVD-friendly, is provided to program stream extractor 140, which includes a transport demultiplexer 240 and a post processor 250. In contrast to a conventional demultiplexer, which separates transport packets into different streams according to a transport packet header, transport demultiplexer 240 lays out the series of transport packet payloads sequentially in a buffer, recreating the original program stream encapsulated by program stream encapsulator 110. This process will be explained below in connection with FIGS. 6B and 7.

Post processor 250 overwrites some data in the extracted program stream with other data, producing a DVD-compliant program stream 155. This process will be explained below in connection with FIG. 7. The DVD-compliant program stream 155 is supplied to DVD storage device 160, or to one or more decoders 260 for playback on a display (not shown).

FIG. 2B is a block diagram showing how the functionality of program stream encapsulator 110 and program stream extractor 140 is distributed in another embodiment. In this embodiment, program stream encapsulator 110 and program stream extractor 140 both reside in DHCT 200, and cable head-end produces a conventional transport stream 270 which does not contain an MPEG program stream.

In this embodiment, the conventional transport stream 270 is received and separated into elementary streams 105 by a conventional transport demultiplexer 280. These elementary streams are supplied to program stream encapsulator 110, which generates dual nature transport stream 135 for storage on storage device 160. The structure and operation of program stream encapsulator 110 in this embodiment is the same as in the embodiment of FIG. 1A, as is the structure and operation of program stream extractor 140, DVD storage device 160, DVD storage device 170, and decoder 260.

The DHCT 200 of FIG. 2B offers functionality that is similar, at the user level, to that of the DHCT 200 in FIG. 2A. However, this embodiment works with conventional transport streams 270, so an upgrade to the head-end is not necessary. Instead, generation of dual nature transport stream 135 is implemented within DHCT 200.

The dual transport stream 135 produced by any embodiment of program stream encapsulator 110 will be referred to herein as a “DVD-friendly” transport stream, referring to the efficiency with which a DVD-compliant program stream 155 can be produced from transport stream 135. As one example of this efficiency, note that post processor 250 is not required to move or copy large amounts of data from one buffer to another in order to transform the DVD-friendly transport stream 135 into a DVD-compliant program stream 155, as would be required by a conventional solution. Instead, post processor 250 substitutes data in some portions of transport stream 135 with other data, for example, overwriting navigation pack placeholder data with actual navigation data.

As another example of this efficiency, note that the receiver of transport stream 135 is not required to re-packetize the elementary streams within transport stream 135 in order to produce DVD-compliant program stream 155. The packetizing and multiplexing performed by program stream encapsulator 110 follows various constraints (discussed in more detail later) which make re-packetizing unnecessary.

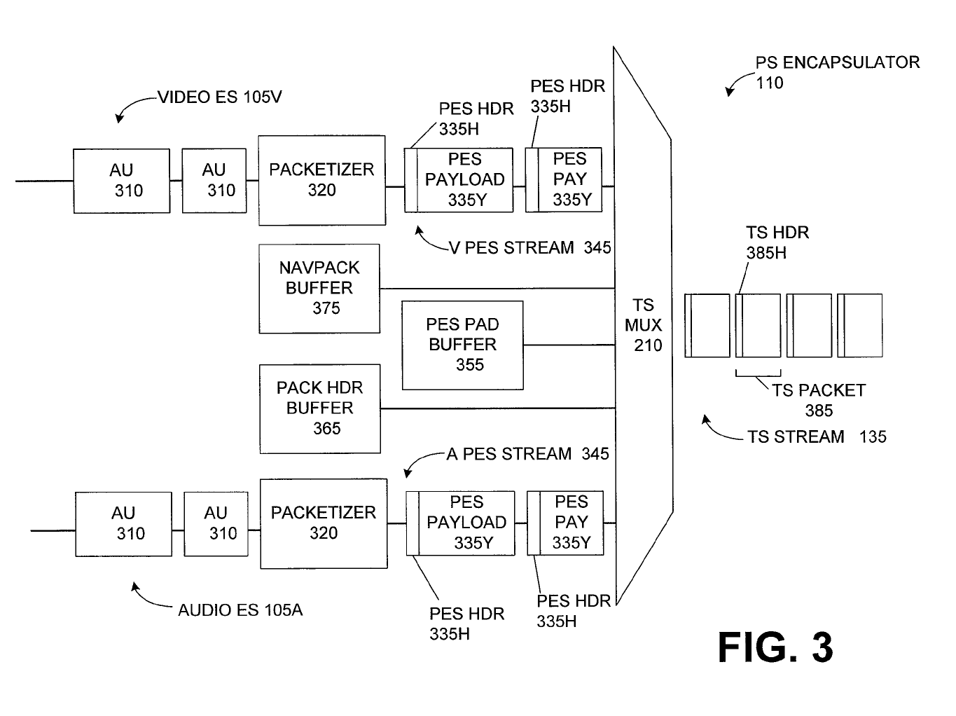

FIG. 3 is a block diagram of one embodiment of program stream encapsulator 110. A person of ordinary skill in the art should understand that the components in FIG. 3 can be implemented in hardware, software, or a combination thereof. Program stream encapsulator 110 receives one or more compressed and encoded elementary media streams 105. Each elementary stream (ES) 105 contains a single type of media, for example, video, audio, or data. In this example embodiment, there are two elementary streams, one video (105V) and one audio (105A). Each ES 105 is composed of access units 310, which are specific to the media type. For example, the access unit 310 for video ES 105V is an encoded picture, and the access unit 310 access unit 310 for audio ES 105A is a collection of encoded samples (i.e., a frame).

Each elementary stream 105 is provided as input to a packetizer 320, which segments the elementary stream 105 into chunks and encapsulates each chunk as a packetized elementary stream (PES) packet 335, comprising a PES header 335H and a PES packet payload 335Y. An access unit 310 may span more than one PES packet 335. A PES packet 335 is variable in length, up to a maximum predefined size. This example embodiment uses one packetizer for each ES—one video PES packetizer (320V) and one audio PES packetizer (320A)—but other arrangements are possible.

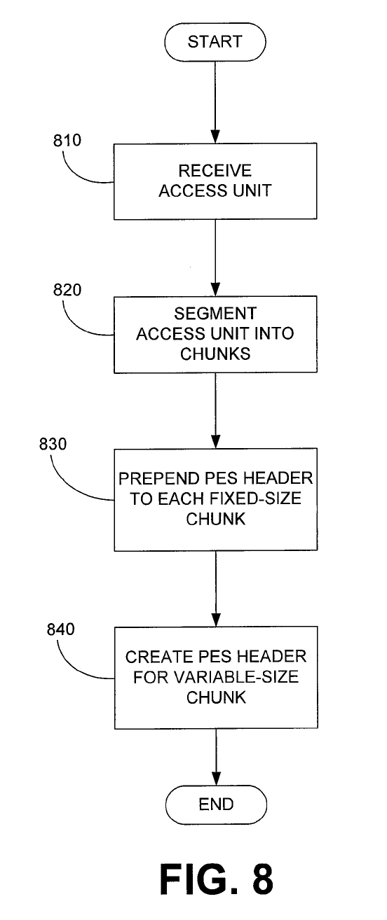

PES header 335H includes a stream identifier, and some PES headers 335H also include decode time stamps (DTS) and presentation time stamps (PTS) which instruct the decoder as to when to decode and/or present the access unit 310. As will be explained in connection with FIG. 8, packetizer 320 enforces a set of constraints, related to alignment, positioning, stuffing, and packet length, that result in a DVD-friendly transport stream.

The PES streams 345 produced by packetizers 320 are supplied as input to transport stream multiplexer 210. A conventional transport stream multiplexer operates to multiplex and encapsulate packetized elementary streams. In contrast, the transport stream multiplexer 210 disclosed herein additionally encapsulates elements of an MPEG program stream in a manner which is compatible with a conventional MPEG receiver, and which allows a program stream extractor 140 to produce a MPEG program stream which is DVD-video-compliant.

To this end, transport stream multiplexer 210 is supplied with input PES streams 345 and with additional pack inputs, where a pack is a fundamental unit of an MPEG program stream. These additional inputs are: a buffer containing a PES padding stream packet 355; a buffer containing a pack header 365; and a buffer containing a navigation pack 375. Although shown as separate elements in FIG. 3, a person of ordinary skill in the art should understand that these buffers are not necessarily elements distinct from transport stream multiplexer 210, but may instead be incorporated into some implementations of transport stream multiplexer 210.

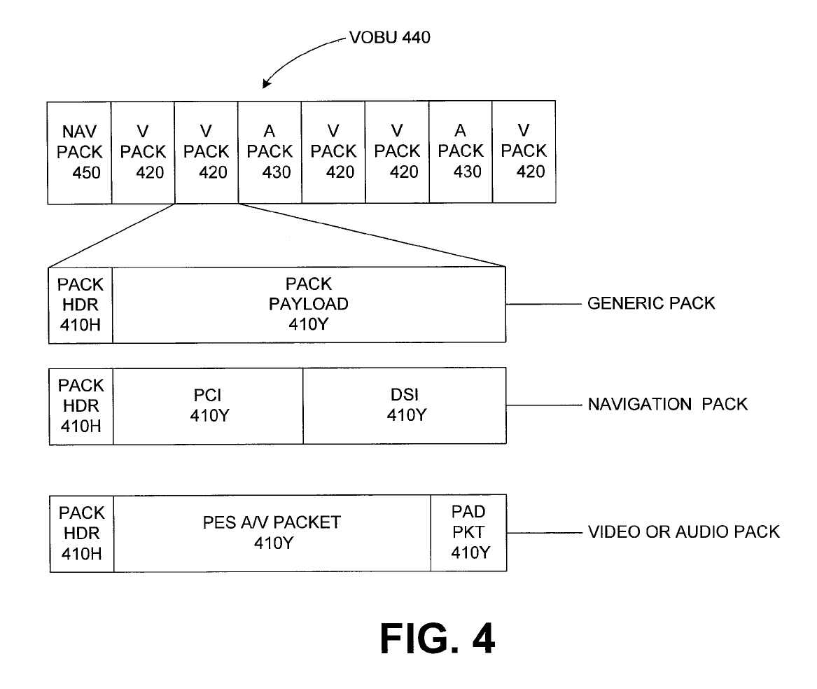

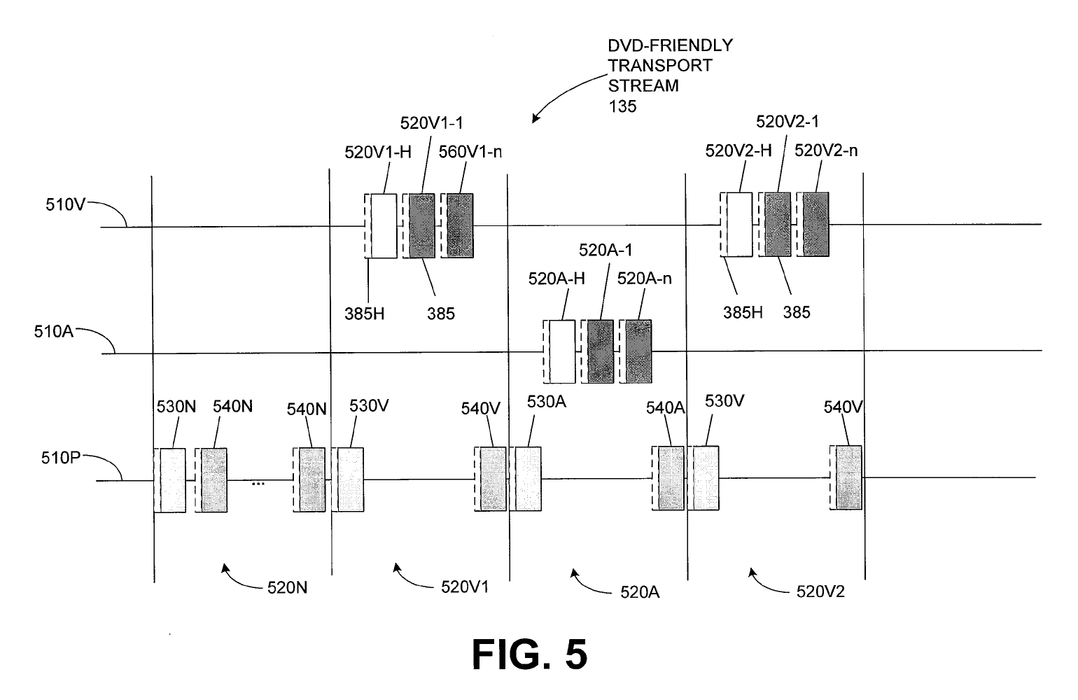

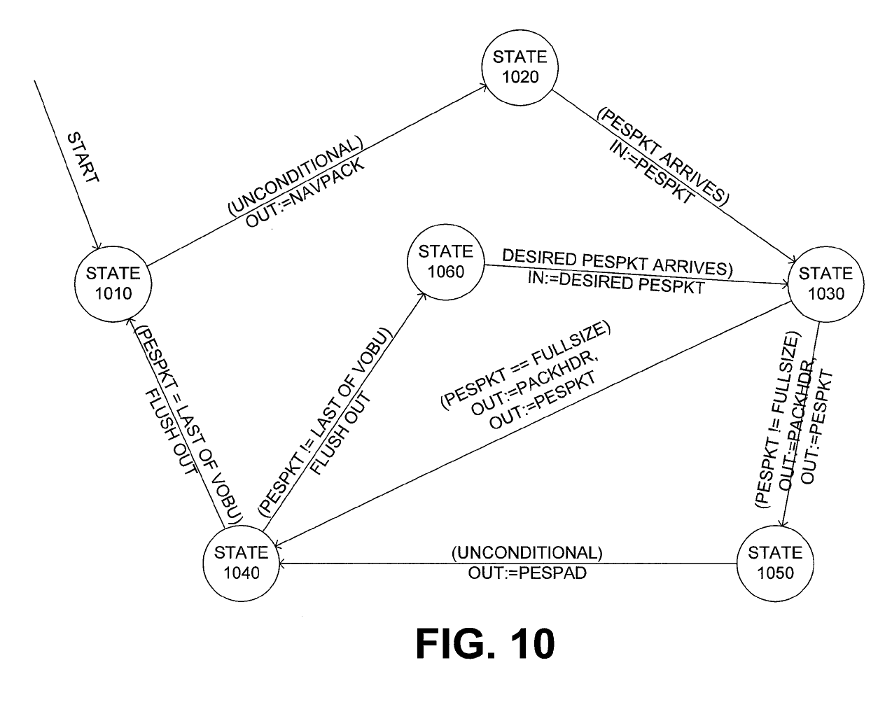

In a process which will be explained further in connection with FIGS. 5 and 10, transport stream multiplexer 210 selects among its PES stream and pack inputs and orders these inputs as needed to form DVD-video packs. The transport stream multiplexer 210 further orders the packs to form DVD-video video object units. (Packs and video object units will be described below in connection with FIG. 4.) In addition to this multiplexing function, transport stream multiplexer 210 also encapsulates input units (PES packets 335, pack header 365, navigation pack 375) into one or more transport packets 385.

The transport packets 385 are of fixed length, so the encapsulation comprises segmenting input units into fixed-size chunks, and prepending a transport packet header 385H to each segment. If the last segment of the PES packet 335 or pack input forms a transport packet smaller than the fixed length, stuffing bytes are added to the transport packet header 385H. The transport packet header 385H includes a packet identifier (PID) which uniquely identifies the elementary stream that is encapsulated within the transport packet.

Transport stream multiplexer 210 also incorporates clocking information into the transport headers 385H, in the form of system clock reference (SCR) and program clock reference (PCR) values. Transport stream multiplexer 210 is constrained to set the PCR to zero at the start of the DVD-friendly transport stream 135. In one embodiment, transport stream multiplexer 210 is further constrained to limit the combined bitrate of audio and video transport packets to 9.8 Mbps, such that no two audio/video packets begin less then 1472/9800 ms apart.

FIG. 4 illustrates the VOBU and pack data structures as defined by the DVD-Video and MPEG-2 standards. Pack 410 is a fixed-size (2048 bytes) data structure comprising a pack header 410H followed by payload 410Y. The information in a pack 410 is all of one type, for example, navigation data, video, audio, or subtitle.

In a video pack (420), audio pack (430), or subtitle pack (not shown), payload 410Y contains one variable-length PES packet 335 and an optional PES padding stream packet 355 as needed to fill up the fixed-size pack. A navigation (NAV) pack contains presentation control information (PCI) and data search information (DSI), which allows a user of a DVD decoder (player) to navigate through the DVD program stream (e.g., start play from a specific chapter).

In one embodiment, the NAV pack 450 transmitted by program stream encapsulator 110 does not contain PCI or DSI data, but instead serves only as a placeholder. Post-processing performed by the receiver of the DVD-friendly transport stream 135 overwrite the placeholder data with appropriate PCI and DSI data. In another embodiment, program stream encapsulator 110 inserts PCI and DSI data in to the transport stream 135 as it is created.

FIG. 4 further illustrates how multiple packs 410 are sequenced to form a larger video object unit (VOBU) 440. Each VOBU 440 starts with a NAV pack 450, optionally followed by video packs 420, audio packs 430, and/or subtitle packs (not shown). The last pack in a VOBU 440 is padded as necessary. Audio packs 430 and subtitle packs within a VOBU 440 have decoder time stamp (DTS) values within the same range as DTS values in the video packs 420 in the VOBU 440. The packs which make up a VOBU 440 represent approximately half a second of the DVD program.

FIG. 5 is a diagram illustrating an example DVD-friendly transport stream 135 constructed by transport stream multiplexer 210. In FIG. 5, transport packets 385 are represented by rectangles, and each transport packet 385 includes a transport packet header 385H. The DVD-friendly transport stream 135 is ordered left-to-right, in increasing order of time, so the first transport packet is to the far left. The PID associated with each transport packet is indicated by the packet's placement on one of horizontal lines 510V, 510A and 510P, and the different types of payload in the transport packet is indicated by different shading within the rectangles.

As in a conventional transport stream, transport stream multiplexer 210 uses one PID for transport packets containing video PES packets, and another for transport packets containing audio PES packets. These PIDs are used on the receiver to demultiplex video and audio to appropriate decoders. Transport stream multiplexer 210 differs from a conventional multiplexer by using an additional “program stream” PID. Transport packets having the program stream PID carry MPEG program stream and DVD-video information. This data allows the program stream extractor 140 in the receiver of the DVD-friendly transport stream 135 to efficiently extract the MPEG program stream carried within the transport stream, as will be discussed below in connection with FIG. 6B.

DVD-friendly transport stream 135 of FIG. 5 includes four different series of transport packets, where each series represents as a pack, and is interpreted by the program stream extractor 140 as such. Thus, the four series of transport packets can be viewed as four logical packs: 520N; 520V1; 520A; and 520V2. These packs in FIG. 5 are logical rather than actual packs because an actual pack, as defined by MPEG-2, is part of an MPEG program stream rather than an MPEG transport stream, and so does not contain transport packet headers 385H.

A pack comprises a pack header, a single PES packet, and PES padding stream packet which fills out the fixed-size pack. (See FIG. 4.) DVD-friendly transport stream 135 distributes the logical packs 520 among three different PIDs. Video and audio PES packets are transported by the video and audio PIDs, respectively. The program stream PID is used to transport navigation packs, pack headers, and PES padding stream packets within audio and video packs. Each of these elements is encapsulated within one or more transport packets 385, where each transport packet 385 includes a transport packet header 385H.

The DVD-friendly transport stream 135 of FIG. 5 carries a single VOBU 440. Since a VOBU 440 begins with a navigation pack (see FIG. 1), the first logical pack 520N represents a navigation pack, with each transport packet in logical pack 520N having the program stream PID. Logical pack 520N starts with a transport packet encapsulating a pack header (530N). As explained earlier in connection with FIG. 4, a logical navigation pack in the DVD-friendly transport stream 135 is only a placeholder, and in the embodiments described herein, the transport packets in the logical navigation pack 520N contain a PES padding stream packet 540.

In a VOBU 440, the navigation pack is followed by other packs. In this example, the next logical pack 520V1 is a video pack, so the next transport packet (530V) encapsulates a pack header. Transport packet 530V has the same program stream PID as the logical navigation pack 520N, rather than having the PID associated with the video stream.

The remaining transport packets in logical pack 520V1 encapsulate a single video PES packet 335. As the first video pack in VOBU 440, the video PES packet 335 in logical pack 520V1 starts a group of pictures (GOP). Since transport packets are small relative to PES packets, transport packet 520V1-H contains a PES header 335H followed by some portion of the PES packet payload 335Y. Successive transport packets (520V1-1, V1-n) carry the remaining PES packet payload 335Y. Transport packets 520V1-1 to -n each have the same video PID, different than the program stream PID, because these packets encapsulate an MPEG PES packet.

The next transport packet in the logical pack 520V1 is a PES padding stream packet 540, and this transport packet has the program stream PID. As explained earlier, the PES padding stream packet 540 is sized to fill up the video pack, so if present, its size depends on the size of the preceding PES packet 335.

A VOBU 440 contains audio packs for audio that will be presented along with the video in the VOBU. In the example of FIG. 5, the next logical pack 520A is an audio pack. Therefore, the next series of transport packets begins with another pack header 530. The transport packet encapsulating this pack header (530A-H) has the program stream PID, rather than having the PID associated with the audio stream.

The remaining transport packets in the logical pack (520A1-n) encapsulate a single audio PES packet 335. These packets each have the same audio PID, different than the program stream PID, because each encapsulates an MPEG PES packet. After the pack header, the next transport packet (520A-H) in logical pack 520A contains an audio PES header 335H followed by some portion of the PES packet payload 335Y, and successive transport packets (520A1-n) carry the remaining audio PES packet payload 335Y. Logical pack 520A ends with a PES padding stream packet 540, carried in the program stream PID.

Note that VOBU 440 finishes with another video pack (530V, 520V2-1, 520V2-n, 540) which contains the end of the GOP started in the first video series 520V1. Thus, VOBU 440 contains video PES packets that form one GOP, which conforms to the DVD-Video specification. VOBU 440 further conforms to the DVD-video specification by containing audio PES packets that contain an integral number of audio frames. The process used by program stream encapsulator 110 to generate packs in a manner which conforms to the DVD-Video specification will be described in further detail in connection with FIG. 8-10.

FIG. 6A is a diagram illustrating how the dual nature transport stream 135 of FIG. 5 is demultiplexed and de-encapsulated by a conventional MPEG transport demultiplexer 280. Demultiplexer 280 removes the transport packet header 385H from each received transport packet 385, and supplies the transport packet payload to an appropriate decoder based on the PID. Thus, packets with a video PID 610 are de-encapsulated to produce a stream of video PES packets 335, which is sent to a video decoder, while packets with an audio PID 620 are de-encapsulated to produce a stream of audio PES packets 335, which is sent to an audio decoder. When conventional demultiplexer 280 receives a transport packet with an unknown PID, the transport packet is discarded. Thus, all packets with a program stream PID 630 are discarded. Because program stream encapsulator 110 encapsulates MPEG program stream elements using the program stream PID, demultiplexer 280 correctly processes the transport stream 135 into component PES streams, without being aware of the fact that this transport stream 135 also encapsulates an MPEG program stream.

In contrast, FIG. 6B illustrates how program stream extractor 140 handles the same dual nature transport stream 135 to extract the encapsulated program stream. Transport demultiplexer 240 (see FIG. 1) removes the transport packet header 385H from each received transport packet 385, as a conventional transport demultiplexer does. However, instead of supplying the transport packet payload to an appropriate decoder based on the PID, transport demultiplexer 240 instead lays out the series of transport packet payloads sequentially in a buffer as shown in FIG. 6B, without distinguishing between different PID values associated with the same program.

The result can be seen by comparing FIGS. 5 and 6B. In the DVD-friendly transport stream 135 shown in FIG. 5, transport packet 540N was immediately followed in time by transport packet 530V, although the two transport packets were logically separated by having different PIDs. In the corresponding program stream produced by transport demultiplexer 240 (FIG. 6B), the transport payload 540N is immediately followed by the transport payload 530V, and the PIDs in the transport headers are irrelevant.

Note that the program stream is made up of actual packs—navigation pack, video packs 420, and audio pack 430—which conform to the MPEG-2 specification. This is so because the logical packs 520 in DVD-friendly transport stream 135 were constructed, as shown in FIG. 5, to start with a pack header, and to contain a PES packet and a PES padding stream packet whose sizes add up to a pack size. Further note that the packs form a series of VOBUs 440 conforming to the DVD-Video specification. This is so because the logical packs 520 in DVD-friendly transport stream 135 were ordered, as discussed earlier in connection in FIG. 5, to start with a navigation pack, and to contain video PES packets that form one GOP, and to contain audio PES packets that contain an integral number of audio frames.

FIG. 7 is a flowchart describing an exemplary method implemented by program stream extractor 140. The process 700 is supplied with a dual-nature transport stream 135, and at block 710, the program association table (PAT) is extracted from transport packets having the well-known PAT PID. Next (block 720), the PAT is examined, and the program map table (PMT) for a desired program is extracted. The communication of the desired program is beyond the scope of this disclosure, but is typically conveyed through user input to the DHCT 200 that selects or tunes a channel.

As a person of ordinary skill in the art should understand, the PAT and PMT cooperate to communicate to an MPEG receiver the association between an MPEG program and the PIDs of its component streams. At block 730, the video, audio and program stream PIDs are extracted from the PMT for the desired program. These PIDs will be “recognized” and processed by program stream extractor 140, and others will be ignored. In one embodiment, the program stream PID is described by a PMT descriptor with a private descriptor, which will be ignored by a conventional MPEG receiver. In another embodiment, the program stream PID is described by a PMT descriptor with a private stream type, which will be ignored by a conventional MPEG receiver.

Once the list of PIDs has been determined, block 740 examines the PID of the next transport packet 385 in the transport stream 135. If the packet PID does not match the list of recognized PIDs, the packet is ignored, and processing returns to block 730, where the next transport packet is examined. If the PID of the current transport packet 385 does match the list of recognized PIDs, then block 750 the transport packet header 385H is removed from the packet, leaving the payload. At block 760, the payload is written to the next sequential location in a VOBU buffer, and an associated VOBU buffer count is incremented by the number of packets in the payload. If the payload contains video, at block 770 video data is extracted and analyzed to produce navigation data. In some embodiments, this navigation data is used by post processor 250 to overwrite placeholder data in the VOBU navigation packs. Examples of the analysis include picture counts and positions, durations, etc. In other embodiments, navigation data is instead included by program stream encapsulator 110 in the navigation packs. Therefore, block 770 is not present in these embodiments.

Next (780), the buffer count is compared to the MPEG-defined pack size. If the buffer count is less than the pack size, then processing returns to block 730 for processing of the next transport packet. If the buffer count is greater than or equal to the pack size, then at block 790 the VOBU buffer is flushed to another storage location (e.g., written to disk), and processing returns to block 730 for processing of the next transport packet.

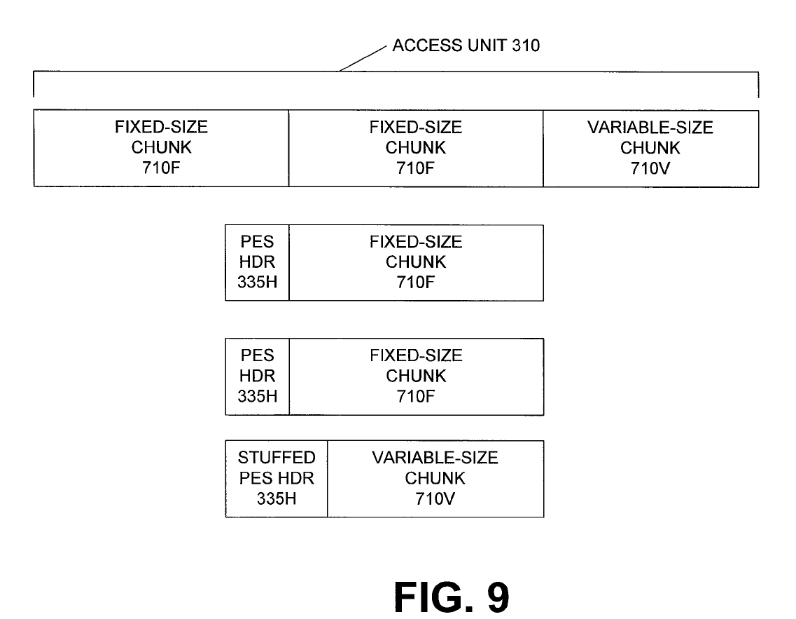

Now that some details of the program stream extractor 140 have been discussed, some details of the program stream encapsulator 110 will be discussed. The process which packetizer 320 uses to construct PES packets 335 from a stream of access units 310 will be described next in connection with FIGS. 8 and 9. The process transport stream multiplexer 210 uses to multiplex PES packets 335, PES padding stream packet 355, pack header 365, and navigation pack 375 to form a DVD-friendly stream carrying VOBUs 440 will then be described in connection with FIG. 10.

FIG. 8 is a flowchart describing an exemplary method implemented by packetizer 320. FIG. 8 will be discussed in conjunction with the sequence diagram of FIG. 9, which illustrates an example PES packet 335 constructed from an access unit 310 by the packetizing process 800.

As shown in FIG. 8, the process 800 begins at block 810, where an access unit 310 is received. Next, at block 820, the access unit 310 is segmented into a sequence of fixed-size chunks (910F in FIG. 9) with any remaining last portion of the access unit 310 forming a variable-size chunk (910V in FIG. 9). The fixed size used in block 820 is calculated by subtracting the size of a DVD-Video pack header from size of a DVD-Video pack, and further subtracting the size of a video/audio PES header. Using the MPEG-2 and DVD-Video standards, that fixed size comes to 2048−14−6=2028, unless the PES header 335H contains a timestamp, in which case the fixed size is reduced accordingly.

Processing continues at block 830, where a PES header is created, initialized and prepended to each fixed-size chunk. (See FIG. 9.) The PES_packet_length field in the PES header is set according to the fixed size, using a non-zero value. PES headers for audio PES packets include stuffing bytes which act as placeholders for substream headers that are processed later by post processor 250. Post processor 250 reduces the PES_header_data_length field in the PES header by four to reveal the location of the substream header. In one embodiment, post processor 250 overwrites the substream header with valid substream data. In another embodiment, the stuffing bytes used by packetizer 320 are valid substream data, and post processor 250 leaves the bytes as is.

Next, at block 840, a PES header 335H for the last, variable-size, chunk is created. Thus, after block 840, a sequence of PES packets 335 has been created from the access unit 310 received in block 810. Block 840 creates a PES header 335H for the last chunk as follows. A PES header 335H can contain up to a maximum number of stuffing bytes. If the last chunk, having the variable size, can be brought up to the fixed size by inserting stuffing bytes, block 840 creates a PES header 335H with the appropriate number of stuffing bytes. (See FIG. 9.)

If the maximum number of header stuffing bytes is not enough to bring the last, variable-size, chunk up to the fixed size, transport stream multiplexer 210 adds a PES padding stream packet 355 to the end of the sequence, after the PES packet created from the last, variable-size chunk. This process will be described further in connection with FIG. 10. In this case, no header stuffing bytes are used.

DVD-Video limits the maximum number of stuffing bytes in a PES header is 7, so if the size of the last chunk is 2021-2027, then 1-7 stuffing bytes are used. The chunk size counts the four audio substream stuffing bytes described above, and these PES header 335H stuffing bytes are in addition to these substream stuffing bytes. A person of ordinary skill in the art should understand that PES header stuffing bytes can be used in this manner since such stuffing bytes are ignored by a decoder.

In accordance with the DVD-Video standard, packetizer 320 ensures that the first audio and video PES packets of each VOBU includes a presentation time stamp (PTS), and a decode time stamp (if appropriate). Additional timestamps may be included, for example, PTS/DTS may be associated with every picture and with every set of N audio frames.

FIG. 10 is a state diagram describing an exemplary method implemented by transport stream multiplexer 210 to form a DVD-friendly transport stream 135. This stream contains PES packets 335 which are organized into packs 410, which are in turn organized into VOBUs 440. The process 1000 starts in state 1010, where transport stream multiplexer 210 writes a navigation pack 375 to an output buffer and transitions to state 1020. In state 1020, transport stream multiplexer 210 waits for arrival of a PES packet 335 from any of packetizers 320. On arrival, transport stream multiplexer 210 stores the PES packet 335 in an input buffer and transitions to state 1030. In state 1030, transport stream multiplexer 210 constructs an appropriate pack header 410H based on the stream type identified in the header of the buffered PES packet 335. The program mux rate in the pack header is set to 10.08 Mbps. The system clock reference (SCR) in the pack header is taken from the instantaneous, actual, PCR time during the current transport packet, rounded to the nearest multiple of 146+86/300 that is greater than the previous SCR value.

If the buffered PES packet 335 is full-sized (i.e., the fixed size used by packetizer 320), then no PES pad packet is required, and transport stream multiplexer 210 transitions to state 1040. If the buffered PES packet 335 is not full-sized, then transport stream multiplexer 210 transitions to state 1050. In state 1050, transport stream multiplexer 210 constructs a PES padding stream packet 355 of the appropriate size. transport stream multiplexer 210 writes the PES padding stream packet 355 to the output buffer, then transitions to state 1040.

The PES padding stream packet 355 is a PES packet with a stream identifier in the PES header 335H set to the predefined padding stream value. The size of PES padding stream packet 355 is set to the size of the buffered PES packet 335 subtracted from the fixed size used by packetizer 320. Thus, the total size of the buffered PES packet 335 plus the PES padding stream packet 355 plus the pack header 410H equals the DVD-Video pack size. A person of ordinary skill in the art should understand that PES padding stream packets can be used in this manner since such packets are ignored by a decoder.

State 1040 can be reached from either state 1050 or state 1030. In state 1040, transport stream multiplexer 210 determines if the buffered PES packet 335 will be last one added to the current VOBU 440. In order to comply with Sections VI.2-19 and 2.4.103 of the DVD-Video spec, transport stream multiplexer 210 constrains a VOBU 440 to contain video PES packets that form one GOP, and audio PES packets that contain integral number of audio frames. Thus, transport stream multiplexer 210 makes this last-in-VOBU determination by examining the contents of video PES packets and audio PES packets as the packets are buffered. Contents of the video PES packets can be parsed to find, for example, an MPEG GOP header within an MPEG sequence header. In this manner, transport stream multiplexer 210 can track the start and end of a GOP, and also count the number of audio frames, thus determining when the VOBU 440 currently being processed is complete.

If transport stream multiplexer 210 determines that the current VOBU 440 is complete, transport stream multiplexer 210 transitions back to state 1010. There, processing of the next VOBU begins with a new navigation pack 375. If the current VOBU 440 is not yet complete, transport stream multiplexer 210 transitions to state 1060, where transport stream multiplexer 210 waits on the arrival of the next PES packet 335 from any of packetizers 320. In either case, transport stream multiplexer 210 has finished processing the output buffer, which now contains a pack header 365 followed by either one full-sized PES packet 335, or a less-than-full-sized PES packet 335 followed by a PES padding stream packet 355. At this point, output buffer contains an entire pack 410, so before transitioning to the next state, transport stream multiplexer 210 makes the output buffer available to transmitter.

In state 1060, reached from state 1040, transport stream multiplexer 210 waits for arrival of another PES packet 335 from any of packetizers 320. On arrival, transport stream multiplexer 210 determines if this newly arrived PES packet 335 should be inserted as the next packet in the current VOBU 440, or if transport stream multiplexer 210 should instead wait for arrival of a PES packet 335 from another stream.

As one example, suppose the last output buffer contained a video PES packet, and then an audio PES packet arrived. If transport stream multiplexer 210 determined that the next PES packet in transport stream 135 should be another video PES packet, transport stream multiplexer 210 would buffer the audio PES packet and remain in state 1060. If transport stream multiplexer 210 instead determines that the newly arrived PES packet 335 comes from the desired stream type, the state transitions to state 1030, where another VOBU 440 is started by inserting a pack header 365.

One embodiment of transport stream multiplexer 210 uses the following criteria while in state 1060 to select from incoming PES packets 335 when forming a VOBU 440. One, the audio associated with the first picture (in display order) is placed after that picture. This first criteria is derived from Section V.14-151 of the DVD-Video specification. Two, the total presentation period for an entire VOBU 440 is not greater than the presentation period of the video contained in the VOBU 440. Accordingly, the last access unit 310 in a VOBU 440—in presentation time—is a video access unit 310. This second criteria is derived from Sections V.15-5 and 15-6 of the DVD-Video specification. To enforce this constraint, transport stream multiplexer 210 may insert an MPEG sequence end code at the end of a picture. Three, the presentation duration of audio in each VOBU, when rounded to the nearest multiple of video field periods and the nearest multiple of 90 kHz units, does not exceed that of video. This second criteria is derived from Sections V.15-5, 5.1.1 of the DVD-Video specification, in order to avoid ending and restarting sequences often. Four, every audio PES packet begins at least two audio frames.

Any process descriptions or blocks in flowcharts should be understood as representing modules, segments, or portions of code which include one or more executable instructions for implementing specific logical functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

The systems and methods disclosed herein can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) an optical fiber and a portable compact disk read-only memory (CD-ROM).

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What I claim is:

1. A method of generating an MPEG transport stream, the method comprising the steps of:
receiving a plurality of elementary streams, each of the elementary streams divided into access units;
generating an MPEG transport stream which encapsulates an MPEG program stream by combining, in order, a program stream pack header, a packetized elementary stream (PES) packet produced from one of the elementary streams, and a PES padding stream packet so that total size of the pack header, PES packet and PES padding stream packet is equal to a size derived from a predefined pack size.

2. The method of claim 1, wherein the generating step further comprises:
packetizing a portion of each of the elementary streams to produce a corresponding plurality of packetized elementary stream (PES) packets;
encapsulating a plurality of program stream pack headers to produce a first plurality of transport packets;
encapsulating the PES packets into a second plurality of transport packets, each transport packet from a different elementary stream having a different program identifier (PID);
encapsulating a plurality of PES padding stream packets to produce a third plurality of transport packets; and
multiplexing transport packets from the first, second and third pluralities in that order to produce a transport stream.

3. The method of claim 2, wherein the encapsulating each of the PES packets step further comprises:
encapsulating a portion of PES packets from one of the elementary streams to produce the second plurality of transport packets, the portion selected such that the total size of PES packets in the portion is equal to a size derived from a predefined pack size and a pack header size.

4. The method of claim 3, wherein the multiplexing step further comprises:
outputting a first transport packet encapsulating a program stream pack header and having a first PID different than the PIDs associated with the elementary streams;
outputting the second plurality of transport packets, following the first transport packet; and
outputting, following the second plurality of transport packets, an encapsulated PES padding stream packet having a second PID different than the PIDs associated with the elementary streams.

5. The method of claim 2, wherein the packetizing step further comprises:
segmenting each access unit into a number of fixed-size chunks and an optional last variable-size chunk;
prepending a PES header to each chunk to produce a plurality of PES packets;
calculating the total size of the PES packets;
stuffing the header of the last PES packet if the size of the last PES packet is within a range derived from the maximum number of stuffing bytes allowed and a predefined pack size; and
creating a PES padding stream packet if the size of the last PES packet is not within the range.

6. The method of claim 2, wherein the encapsulating a plurality of PES padding stream packets further comprises the step of:
encapsulating a plurality of PES padding stream packets to produce a third plurality of transport packets, each of the third plurality having a PID different than the PIDs associated with the elementary streams.

7. A system for generating an MPEG transport stream, the system comprising:
a first packetizer configured to receive a first elementary stream and to packetizing the first elementary stream to produce a corresponding first plurality of packetized elementary stream (PES) packets;
a second packetizer configured to receive a second elementary stream and to packetizing the first elementary stream to produce a corresponding second plurality of packetized elementary stream (PES) packets;
logic configured to encapsulate a program stream pack header into a pack header transport packet;
logic configured to encapsulate PES packets in the first and second pluralities into corresponding first and second pluralities of PES transport packets;
logic configured to encapsulate a PES padding stream packet into a PES pad transport packet; and
a transport multiplexer to output the pack header transport packet, the first pluraltity of PES transport packets, the second plurality of transport packets, and the PES pad transport packet, in that order, to produce a transport stream.

8. The system of claim 7, wherein the logic configured to encapsulating PES packets further comprises:
logic configured to encapsulating a portion of PES packets in the first plurality to produce the corresponding first plurality of transport packets, the portion selected such that the total size of PES packets in the portion is equal to a size derived from a predefined pack size and a pack header size.

9. The system of claim 7, wherein the multiplexer further comprises:
logic configured to output the pack header transport packet with a first PID different than the PIDs associated with the elementary streams;
logic configured to output the first plurality of PES transport packets, following the pack header transport packet;
logic configured to output the second plurality of PES transport packets, following the first plurality of PES transport packets; and
logic configured to output, following the second plurality of PES transport packets, the PES pad transport packet with a second PID different than the PIDs associated with the elementary streams.

10. The system of claim 7, wherein the first elementary stream is divided into access units, and the first packetizer further comprises:
logic configured to segment each access unit into a number of fixed-size chunks and an optional last variable-size chunk;
logic configured to prependa PES header to each chunk to produce a plurality of PES packets;
logic configured to calculate the total size of the PES packets;
logic configured to stuff the header of the last PES packet if the size of the last PES packet is within a range derived from the maximum number of stuffing bytes allowed and a predefined pack size; and
logic configured to create a PES padding stream packet if the size of the last PES packet is not within the range.

11. The system of claim 7, wherein the logic configured to encapsulate a PES padding stream packet further comprises:
logic configured to encapsulate the PES padding stream packet into a PES pad transport packet having a PID different than the PIDs associated with the elementary streams.

12. A digital home communication terminal (DHCT) comprising:
a program stream encapsulator configured to encapsulate an MPEG program stream into a MPEG transport stream, the MPEG program stream derived from a plurality of MPEG elementary streams and at least one program element;
a storage device configured to store the MPEG transport stream; and
a program stream extractor configured to extract the encapsulated MPEG program stream from the stored MPEG transport stream and to process the extracted MPEG program stream to produce a DVD-compliant program stream.

13. The DHCT of claim 12, wherein the MPEG transport stream is divided into a plurality of transport packets, and the program stream extractor further comprises:
a transport demultiplexer configured to extract a payload from each of the plurality of packets and to write out the payloads sequentially in a buffer.

14. The DHCT of claim 13, wherein the program stream extractor further comprises:
a post-processor configured to overwrite data in a navigation pack in the extracted MPEG program stream with navigation data derived from payload extracted by the transport demultiplexer.

15. The DHCT of claim 12, further comprising:
a receiver configured to receive a MPEG transport stream carrying the plurality of MPEG elementary streams.

16. The DHCT of claim 12, wherein the receiver further comprises an RF tuner.

17. The DHCT of claim 12, further comprising:
a second storage device configured to store the DVD-compliant program stream.

18. The DHCT of claim 17, wherein the second storage device is a optical-disk drive.
